(19) United States
(12) Patent Application Publication
(10) Pub. No.: US 2011/0112705 A1
(43) Pub. Date: May 12, 2011

(54) ELECTRONIC CONTROL DEVICE FOR A PILOTING MEMBER WITH MULTIFUNCTIONAL MICROCONTROLLERS, PILOTING DEVICE AND AIRCRAFT

(75) Inventor: Cédric ANTRAYGUE, VILLEFRANCHE DE ROUERGUE (FR)

(73) Assignee: RATIER FIGEAC, FIGEAC (FR)

(21) Appl. No.: 12/941,346

(22) Filed: Nov. 8, 2010

(30) Foreign Application Priority Data
Nov. 6, 2009 (FR) 0905344

(51) Int. Cl. B64C 13/04; G05D 1/00

(52) U.S. Cl. 701/3

(57) ABSTRACT

An electronic control device for an aircraft piloting member mounted on an electromechanical supporting box (23, 24) includes at least one actuating motor on at least one degree of freedom, and sensors associated with the piloting member to detect at least the position thereof on each degree of freedom. A command/monitoring unit (47, 48) of the piloting member has at least one electronic microcontroller (52 to 55) adapted to:
command at least one motor on one degree of freedom,
receive signals of sensors (83, 93) on another degree of freedom,
carry out monitoring of the signals to detect any deviation thereof. A piloting device and an aircraft including such an electronic control device are also disclosed.

The invention relates to an electronic control device for an aircraft piloting member, called the controlled piloting member, connected to at least one same flying member of the aircraft, said controlled piloting member being mounted on an electromechanical supporting box on at least one degree of freedom—in particular on more than one degree of freedom—, said electromechanical supporting box comprising:
for each degree of freedom of the controlled piloting member with respect to said electromechanical supporting box, at least one motor for actuating the controlled piloting member on one of said at least one degree of freedom,
sensors associated with the controlled piloting member to detect at least the position thereof on said at least one degree of freedom.

It relates more particularly to an electronic control device for a piloting member belonging to a piloting device equipped, for each flying member of the aircraft, with two such piloting members connected (by a completely mechanical kinematic chain or at least partly electrically) to this flying member, so that the aircraft can be piloted simultaneously by two people: a captain and a copilot. Throughout the text, the term “piloting” and its derivatives denote, unless otherwise stated, the flying of an aircraft by at least one human pilot operating at least one piloting member such as a stick, handle, rudder bar, pedal, etc., connected to at least one flying member such as a control surface or a throttle control of the aircraft, etc. The term “command” and its derivatives denote in the traditional manner in aeronautics the fact of supplying a device with signals which bring about a predetermined action of said device. The term “monitor” and its derivatives denote in the traditional manner in aeronautics the fact of processing measurements carried out on a device and comparing them with predetermined values to detect the occurrence of operating faults (i.e. faults arising from any failure in a system (device and/or software), as opposed in particular to use faults arising not from a failure, but from errors of a user (pilot or copilot) or from the aircraft departing from its flight envelope). An operational control device for a piloting member is a device having at least one monitoring function for this piloting member, and also being able to perform other functions, in particular for commanding this piloting member.

A piloting device comprising servo coupling (logically and electronically) of a pilot's stick and a copilot's stick has already been proposed. Motors enable simulation of the feel of traditional mechanical sticks and the tracking of each stick by the other.

Such a device poses the problem of its reliability and of monitoring the occurrence of possible operating faults (failures) to ensure good operating safety.

EP 0 759 585 poses this problem and points out that such aeronautical systems must be fault tolerant and in particular integrate redundant devices. The solution recommended by this document consists in providing, for each piloting stick, on the one hand complete redundancy of the motors, detection sensors and circuits for generating force feedback sensations, and on the other hand connected command and monitoring computers for “self-monitoring” the command signal of the motor associated with this stick, comparing it with a motor current signal, and comparing measured voltage signals with a reference signal, the monitoring computer monitoring the command computer, the two computers being capable of deactivating the motor. Such a solution, which is traditional in its principle, is heavy, complex and costly in its implementation and its operation. In particular, it requires a specific monitoring computer for each stick. In addition, it remains imperfect insofar as certain failures which are liable to occur on such a monitoring computer will not necessarily be detected themselves.

The invention therefore aims to overcome these disadvantages by proposing an electronic control device which has improved reliability and operating safety, in particular makes it possible to detect also any failure liable to occur on a circuit used for the monitoring of the operation of the device, which remains operational in the event of a fault occurring on any of its components, and which moreover is simple, light, compact, inexpensive and compatible with its implementation on an industrial scale on board any aircraft, including on board an aircraft already in operation.

More particularly, the invention aims to propose such a control device which is simple, inexpensive to design, to manufacture, and in its operation, including in terms of energy consumption.

Throughout the text, the term “adapted to” applied to a device such as a circuit is used in the usual way to denote a technical function performed by this device.

The invention therefore relates to an electronic control device for an aircraft piloting member, called the controlled piloting member, connected to at least one flying member of the aircraft, said controlled piloting member being mounted and guided on an electromechanical supporting box on at least one degree of freedom, said electromechanical supporting box comprising:
for each degree of freedom of the controlled piloting member with respect to said electromechanical supporting box, at least one motor for actuating the controlled piloting member on said degree of freedom,
sensors associated with the controlled piloting member to detect at least the position thereof on at least one degree of freedom,
   characterised in that it comprises a command/monitoring unit of the controlled piloting member, in that said command/monitoring unit comprises at least one electronic microcontroller, and in that each of said at least one electronic microcontroller is adapted to:
deliver command signals, called monitored signals, for at least one actuating motor on one degree of freedom, called commanded degree of freedom, of the controlled piloting member,
receive signals delivered by sensors chosen from
   sensors associated with at least a second degree of freedom, called the monitored degree of freedom of the controlled piloting member, said monitored degree of freedom being distinct from said commanded degree of freedom,
   and sensors associated with at least one monitored degree of freedom f the controlled piloting member of another piloting member distinct from said controlled piloting member, said monitored degree of freedom of said another piloting member being distinct from said commanded degree of freedom of the controlled piloting member,
   carry out a monitoring digital processing of said monitored signals, said monitoring digital processing being adapted to detect any deviation of said signals corresponding to an operating fault and to generate a signal representing such an operating fault.

Thus, in a device according to the invention, each electronic microcontroller is multifunctional in the sense that it can enable on the one hand the commanding of at least one actuating motor on one degree of freedom of the corresponding controlled piloting member, and on the other hand the monitoring of the operation of at least one other degree of freedom (monitored degree of freedom) which is different from the commanded degree of freedom, i.e. which is chosen from another degree of freedom of the same controlled piloting member, and a similar or different degree of freedom of another piloting member than the controlled piloting member (in particular of a second piloting member connected to the same flying member of the aircraft). Such a device makes it possible in particular to detect any operating fault of a piloting member and/or of an actuating motor and/or of an electronic microcontroller associated with a piloting member—in particular an electronic microcontroller incorporated in a command/monitoring unit of a piloting member.

The inventors have in fact determined that, contrary to the traditional approach in aeronautics according to which the operating safety is obtained by a redundancy of the components, each component being monofunctional, a device according to the invention in which the microcontrollers are reduced in number and multifunctional offers in actual fact a reliability and operating safety just as good, or event better, owing to its simplicity and the fact that the command and monitoring tasks allocated to each microcontroller can be defined so as to optimise the safety, in particular by carrying out cross-monitoring of the different degrees of freedom, and even of different piloting members.

The invention applies furthermore particularly advantageously to the case of so-called active piloting members, i.e. ones equipped with actuating motors and command circuits which generate a simulated force feedback sensation on each degree of freedom of the piloting member. In fact, the electronic control devices according to the invention can then carry out particularly effective monitoring—in particular cross-monitoring—of these motors and command circuits, and can do so with a reduced number of microcontrollers.

Thus, advantageously in a device according to the invention, said electromechanical supporting box comprises force sensors associated with the controlled piloting member to detect the forces imparted thereto on each commanded degree of freedom, each command/monitoring unit comprises inputs for receiving the signals delivered by said force sensors, and each of said at least one electronic microcontroller is adapted to receive said monitored signals, and to deliver command signals for at least one actuating motor so as to create an electrically simulated variable force feedback sensation in the piloting member.

Furthermore, advantageously and according to the invention, the controlled piloting member belongs to a piloting device comprising said controlled piloting member and another piloting member, called the other piloting member, both piloting members being connected to at least one same flying member of the aircraft, and in that said command/monitoring unit of the controlled piloting member comprises:
inputs, called cross-monitoring inputs, for receiving monitored signals delivered by sensors associated with said other piloting member, for each degree of freedom, at least one electronic microcontroller receiving said cross-monitored signals at the cross-monitoring inputs, and said microcontroller being adapted to deliver command signals for at least one actuating motor on said commanded degree of freedom of the controlled piloting member so as to carry out electronic servo coupling of the two piloting members.

Thus, the two piloting members are electronically coupled to one another, the piloting device comprising at least one command/monitoring unit capable of carrying out such an electronic coupling by automatic control. Nevertheless, the invention applies also to a piloting device in which the two piloting members are not coupled, but on the contrary are independent of one another. It also applies to a piloting device comprising a single piloting member.

Thus, an electronic control device according to the invention can have the function, on the one hand, of ensuring the operational coupling of two piloting members and, on the other hand, of performing the commanding of motors associated with the degrees of freedom of the piloting member so as to achieve an electrically simulated variable force feedback sensation.

Furthermore, advantageously a device according to the invention is also characterised in that the controlled piloting member belongs to a piloting device comprising said piloting members being mounted on two respective electromechanical boxes with the same degrees of freedom and both connected to at least one same flying member of the aircraft, and in that said command/monitoring unit comprises:
for each of said monitored degree of freedom of the controlled piloting member, an electronic microcontroller, called main monitoring microcontroller, for digital processing of said monitored signals delivered by sensors associated with the controlled piloting member, and adapted to detect any deviation of these signals corresponding to an operating fault and to generate a signal representing such an operating fault,
inputs, called cross-monitoring inputs, for receiving monitored signals, said cross-monitored signals, delivered by sensors associated with said other piloting member,
for each monitored degree of freedom of said other piloting member, one and only one electronic microcontroller, called the cross-monitoring microcontroller, specific to this degree of freedom, said cross-monitoring microcontroller being adapted to carry out digital processing of said cross-monitored signals received at said cross-monitoring inputs, and to detect any deviation of these signals corresponding to an operating fault and to generate a signal representing such an operating fault.

Advantageously and according to the invention, said cross-monitoring inputs comprise at least one input for receiving at least one cross-monitored position signal of said other piloting member, delivered by a position sensor associated with said other piloting member.

In addition, advantageously such a device according to the invention is also characterised in that said cross-monitoring inputs comprise at least one input for receiving at least one cross-monitored force signal, representing forces actually exerted on the other piloting member, delivered by at least one force sensor associated with said other piloting member, and in that, for each degree of freedom, said cross-monitoring electronic microcontroller is adapted to compare a value, called the force measured value, determined at least from said cross-monitored force signal, with a reference value calculated according to a predetermined law from at least one position signal of said other piloting member.

Advantageously and according to the invention, said cross-monitoring electronic microcontroller is adapted to compare the difference between said force measured value and said reference value with a predetermined threshold value, and to generate a signal representing a fault when this difference exceeds said predetermined threshold value.

In an advantageous embodiment and according to the invention, the controlled piloting member belongs to a piloting device comprising said piloting members being mounted on two respective electromechanical boxes with the two same degrees of freedom and both connected to at least one same flying member of the aircraft, said command/monitoring unit comprises:
a first electronic microcontroller having the functions:
of delivering master command signals for a first actuating motor on a first degree of freedom of the controlled piloting member,
of delivering slave command signals for a first actuating motor on a second degree of freedom of the controlled piloting member,
of carrying out main monitoring of the controlled piloting member on the second degree of freedom,
of carrying out cross-monitoring of the other piloting member on one of the two degrees of freedom, in particular the second degree of freedom,
   a second electronic microcontroller having the functions:
of delivering master command signals for a second actuating motor on a second degree of freedom of the controlled piloting member,
of delivering slave command signals for a second actuating motor on the first degree of freedom of the controlled piloting member,
of carrying out main monitoring of the controlled piloting member on the first degree of freedom,
of carrying out cross-monitoring of the other piloting member on the other of the two degrees of freedom (i.e. on the degree of freedom other than that for which the first microcontroller carries out the cross-monitoring of the other piloting member), in particular the first degree of freedom.

Furthermore, advantageously and according to the invention, said command/monitoring unit is encapsulated in a box which can be mounted on the electromechanical supporting box of the controlled piloting member.

It should be noted in this regard that an electronic control device according to the invention—and in particular said box containing the command/monitoring unit—can be designed perfectly symmetrically in its connection and in its operation, so that it applies equally well to a piloting member—in particular a stick (this term including a mini-stick)—of a pilot as to a piloting member—in particular a stick—of a copilot, without requiring hardware or software modifications. Thus, a same box comprising an electronic control device according to the invention—in particular a command/monitoring unit—can be mounted and connected alternatively equally well on the electromechanical supporting box of a pilot's stick as on the electromechanical supporting box of a copilot's stick. This results particularly in considerable savings in terms of manufacture on an industrial scale.

The invention also covers a piloting device of an aircraft comprising at least one piloting member connected to at least one flying member of the aircraft, characterised in that it comprises an electronic control device according to the invention for a piloting member of the aircraft.

More particularly, the invention covers a piloting device comprising two piloting members both connected to at least one same flying member of the aircraft, characterised in that it comprises, for each piloting member, an electronic control device according to the invention—in particular a command/monitoring unit—specific to each piloting member. Thus, a piloting device according to the invention comprises two electronic control devices according to the invention—in particular two command/monitoring units—, one for each piloting member, and each electronic control device—in particular with its command/monitoring unit—is associated with one of the two piloting members (in particular incorporated in a box mounted on its electromechanical supporting box) and performs functions of commanding and main monitoring of the controlled piloting member with which it is associated, and, preferably, cross-monitoring of the other piloting member.

Advantageously and according to the invention, the two electronic control devices according to the invention are identical. In fact, they are symmetrical in their design, their connection and their operation. It should be noted in this regard that an electronic control device according to the invention is incorporated directly in the piloting member and fixed to its electromechanical supporting box, and is therefore not formed of a system outside the two piloting members (as would be case for example of a centralised device interposed between the two piloting members).

The invention also covers an aircraft characterised in that it comprises at least one piloting device according to the invention, in particular a piloting device comprising two roll and pitch piloting sticks. In an aircraft according to the invention, each piloting stick is equipped with an electronic control device according to the invention.

The invention also relates to an electronic control device, a piloting device and an aircraft characterised in combination by all or part of the features mentioned above or below.

Other objects, features and advantages of the invention will become apparent on reading the following description which refers to the appended figures showing, by way of non-limiting example, a preferred embodiment of the invention, and in which:

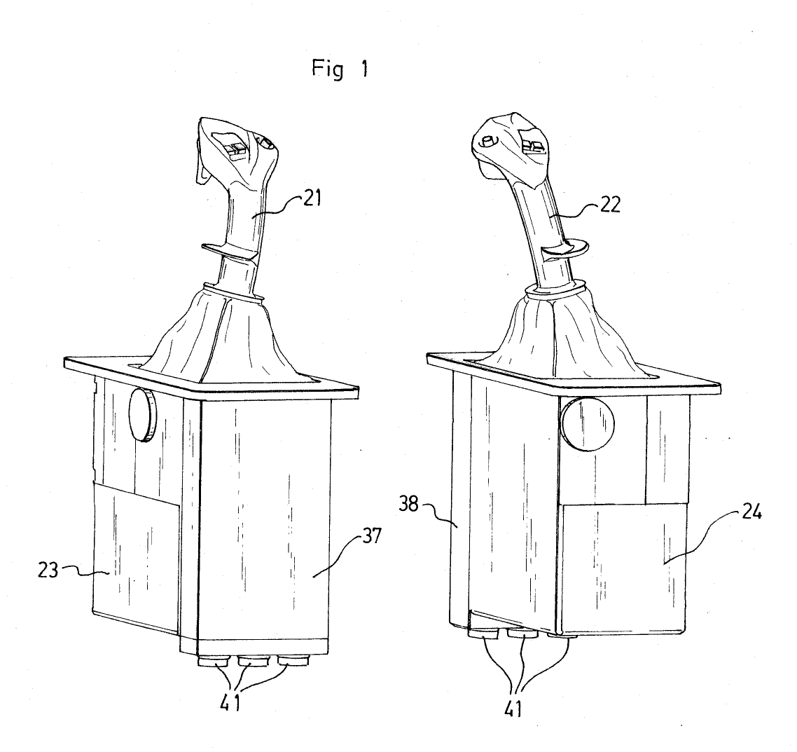

FIG. 1 is a diagrammatic partial perspective representation of two piloting members of a piloting device according to the invention,

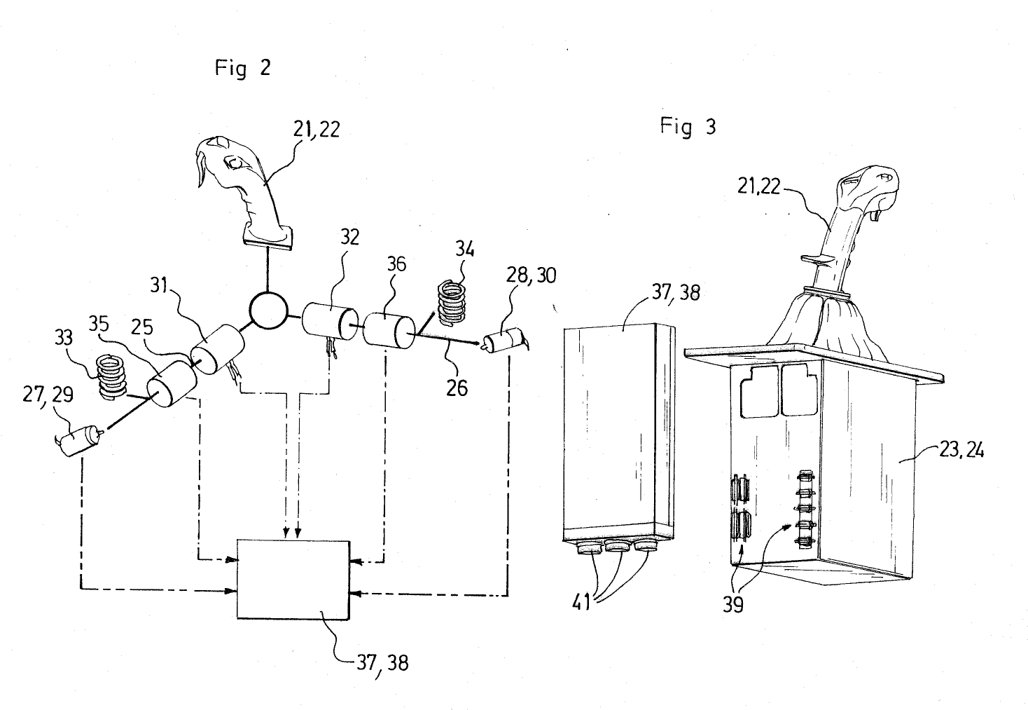

FIG. 2 is a diagrammatic representation showing the main components of a piloting member of FIG. 1,

FIG. 3 is a diagrammatic partially exploded perspective representation of a piloting member of FIG. 1,

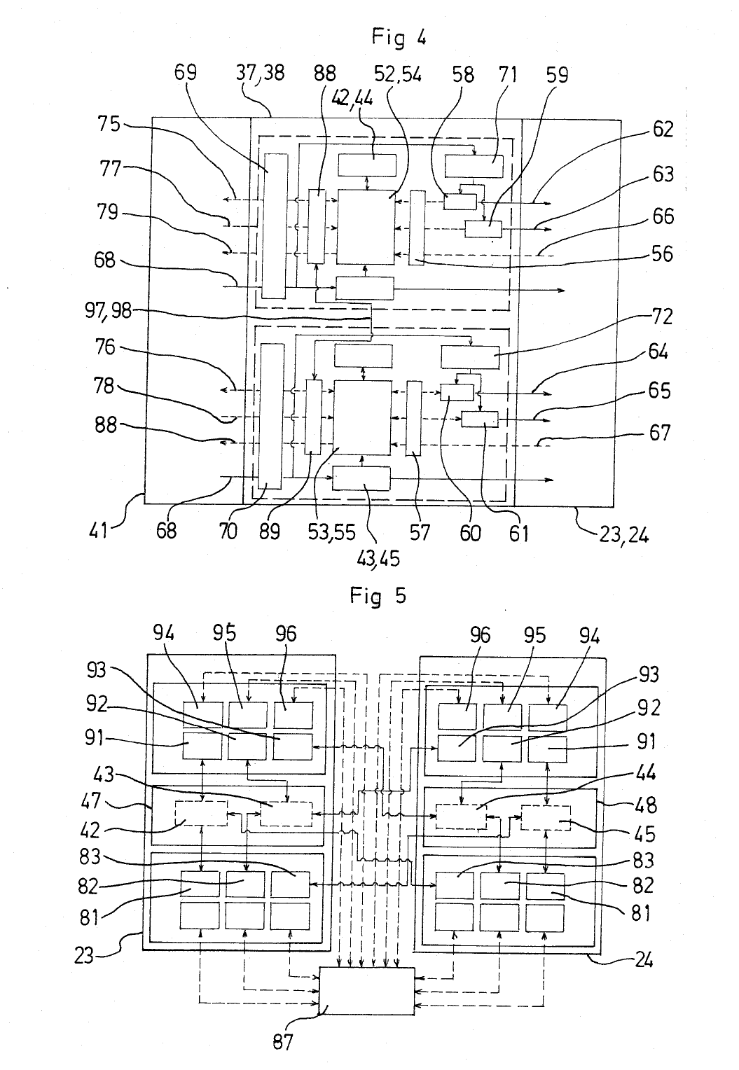

FIG. 4 is a block diagram illustrating the general architecture of a command/monitoring unit of a piloting member of an electronic control device according to the invention,

FIG. 5 is a block diagram illustrating the connections between the sensors and the different paths of the two piloting members of a piloting device according to the invention,

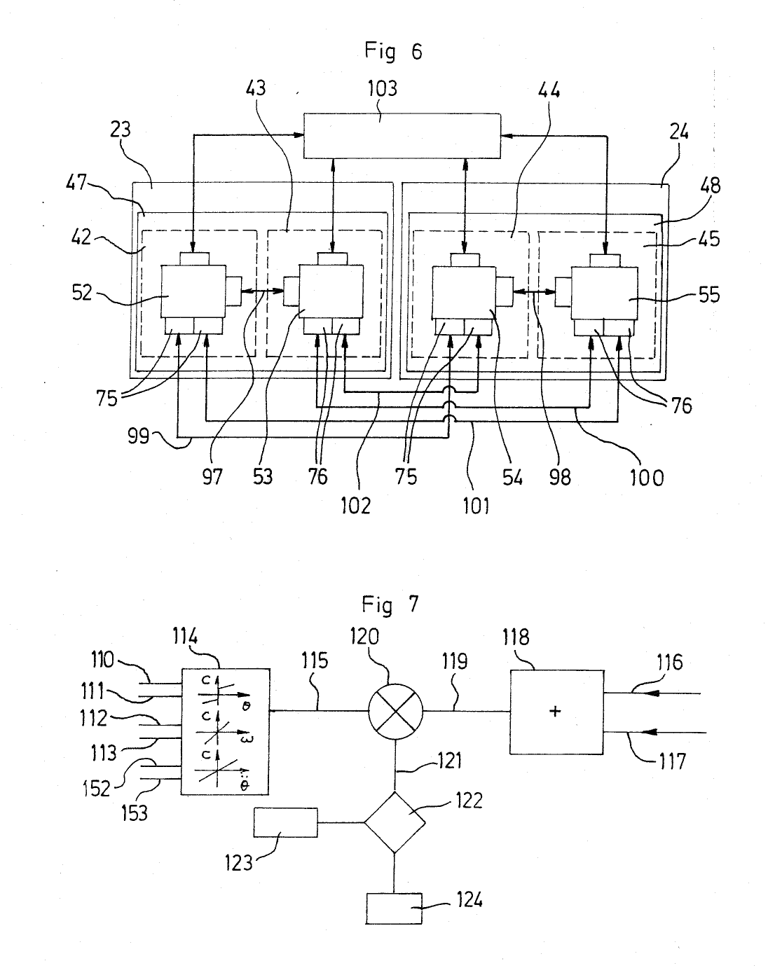

FIG. 6 is a block diagram illustrating the connections between the electronic microcontrollers of the two electronic control devices according to the invention of the two piloting members of a piloting device according to the invention,

FIG. 7 is a logic diagram illustrating an example of logic employed for the cross-monitoring in a device according to the invention,

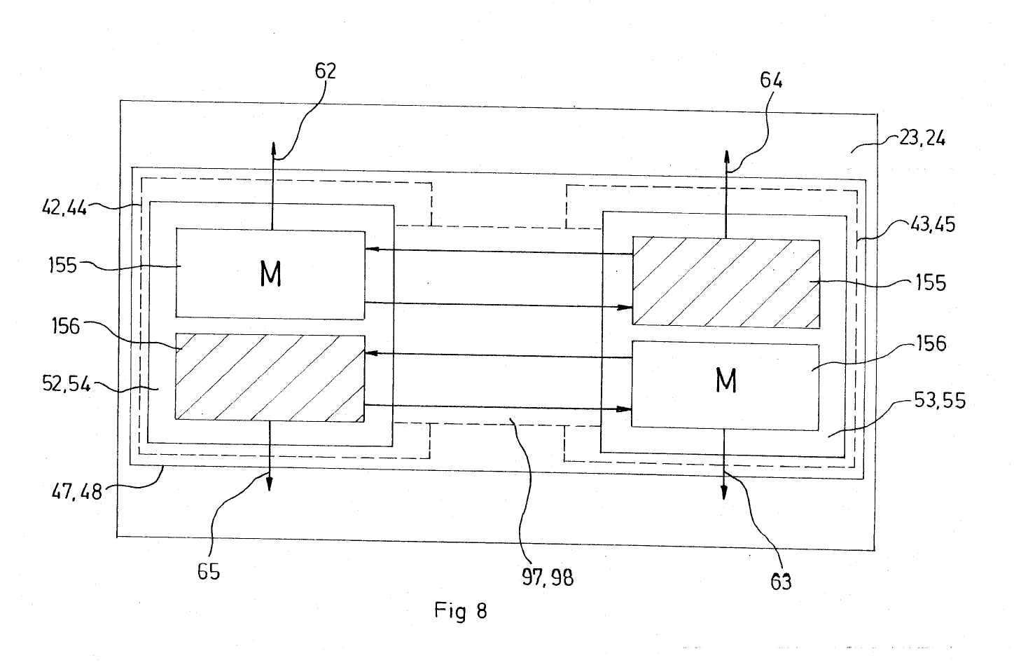

FIG. 8 is a block diagram illustrating the architecture for normal operation of the electronic command/monitoring unit of a piloting member of a piloting device according to the invention,

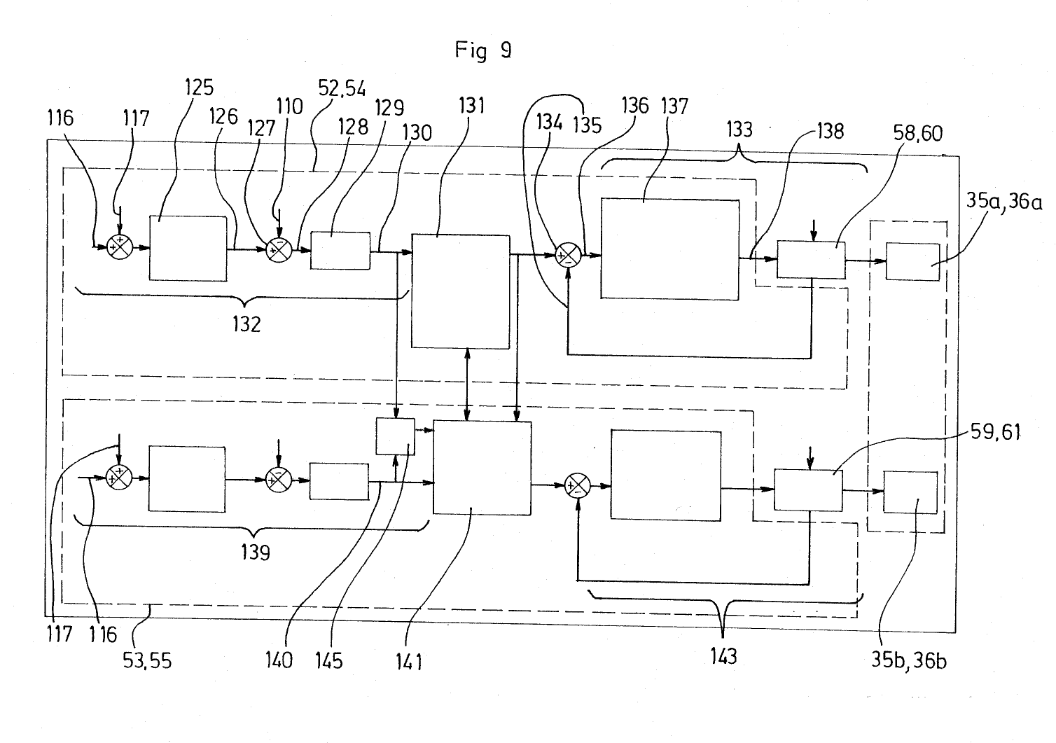

FIG. 9 is a block diagram illustrating the automatic controls employed for one degree of freedom in an electronic control device of a piloting member according to the invention,

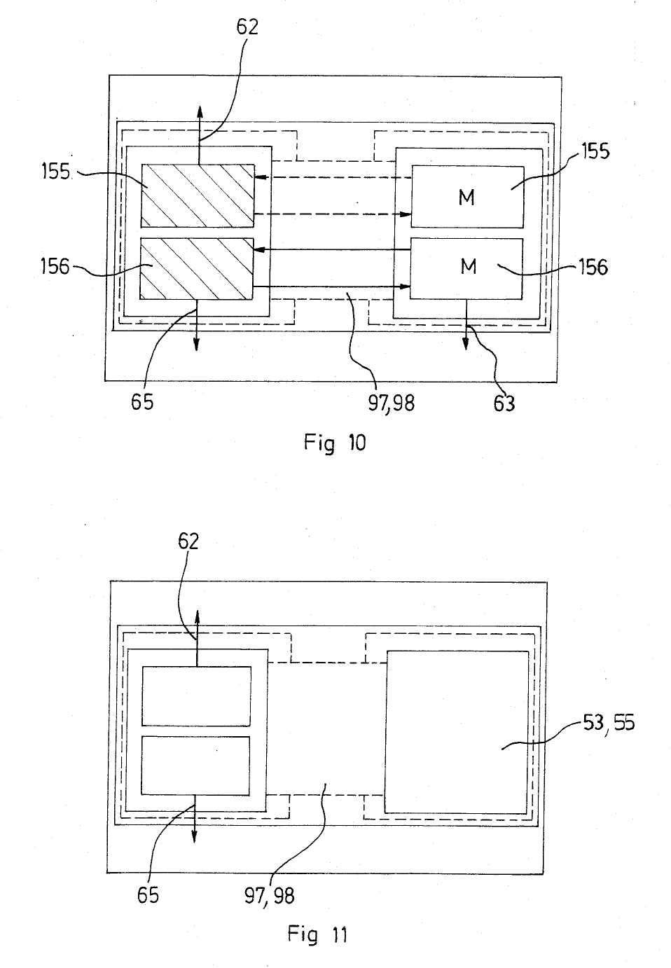

FIGS. 10 and 11 are similar to FIG. 8 and show the architecture for operation in the event of an electrical supply or operating fault of the motor on one degree of freedom, and, respectively, in the event of an operating fault of one of the electronic microcontrollers.

FIG. 1 shows a piloting device according to the invention which, in the example, comprises two pivoting mini-sticks 21, 22 for piloting an aircraft, one, 21, of which is intended to be used by the captain, and the other, 22, of which is intended to be used by the copilot.

Each mini-stick 21, 22 is mounted on an electromechanical supporting box 23 and 24, respectively, which incorporates (FIG. 2) in particular the kinematics for guiding the mini-stick in rotation about the pitch axis 25 and the roll axis 26, and, for each of these axes, at least angular position sensors 27, 28, preferably also angular velocity sensors 29, 30 (in a variant not shown also angular acceleration sensors), and force sensors 31, 32, return springs 33, 34 associated with levers making it possible to return the mini-stick to the neutral position, and actuating motors (namely two motors 35a, 35b and 36a, 36b per axis, shown and designated collectively by the references 35, 36 in FIG. 2) making it possible in particular to impart a torque to the mini-stick in order to create an electrically simulated variable force feedback sensation. The angular position sensors 27, 28 may comprise sensors which detect the angular position of the mini-stick 21, 22 itself and/or sensors which detect the angular position of the drive shaft of at least one—in particular each—actuating motor 35, 36. All the sensors are arranged to supply signals continuously and in real time.

Such piloting members and their electromechanical supporting box are well known per se and will not be described in more detail. The invention further applies to all types of piloting members, including for example rudder bars, engine control levers of the aircraft, etc. It applies to piloting members which may comprise any number of degrees of freedom chosen from rotations and translations.

Each electromechanical supporting box 23, 24 receives a second box, called the control box 37, 38, which incorporates an electronic command/monitoring unit 47, 48 associated with the corresponding piloting member 21 and 22, respectively. As shown in FIG. 3, this control box 37, 38 is directly mounted by screws on a vertical face of the electromechanical supporting box 23, 24, and these two boxes 37, 38 and 23, 24 are electrically connected to one another via appropriate connectors 39. The connectors borne by the vertical face of the electromechanical supporting box 23, 24 are electrically connected to the various electrical elements incorporated inside this box, i.e. the above-mentioned sensors and motors.

Each control box 37, 38 is also equipped with connectors 41 enabling its connection to the control box 38, 37 associated with the other piloting member (in particular for the transmission of signals enabling the cross-monitoring described below), and to various other electrical systems and/or computer systems of the aircraft, in particular an automatic piloting computer system.

FIG. 4 shows diagrammatically the general architecture of an electronic command/monitoring unit 47, 48 incorporated in one of the control boxes 37, 38. In this figure, the electromechanical box 23, 24 is schematised on the right, and the external connectors 41 are schematised on the left.

In the embodiment shown in the figures, each command/monitoring unit 47, 48 comprises two paths 42, 43 and 44, 45, respectively, and each path 42, 43, 44, 45 comprises principally a single electronic microcontroller 52, 53, 55, 55. Each path makes it possible to command one of the two actuating motors of each axis of rotation at 50% of the torque which is to be produced on this axis. In other words, each electronic command/monitoring unit 47, 48 comprises only two microcontrollers 52, 53 and 54, 55, respectively, and each microcontroller is active on both axes of rotation, to command 50% of the torque on each axis of rotation via one of the two motors.

In addition, each microcontroller 52, 53, 54, 55 is also adapted to perform operational monitoring functions as described in more detail below.

As can be seen in FIG. 4, the microcontroller 52, 54 of the first path 42, 44 supplies, continuously and in real time via a formatting circuit 56, command signals 62 for the electrical supply circuit 58 of a first actuating motor coupled to the axis of rotation in roll, and command signals 63 for the electrical supply circuit 59 of a second actuating motor coupled to the axis of rotation in pitch. The microcontroller 53, 55 of the second path 43, 45 supplies, continuously and in real time via a formatting circuit 57, command signals 64 for the electrical supply circuit 60 of a third actuating motor coupled to the axis of rotation in roll, and command signals 65 for the electrical supply circuit 61 of a fourth actuating motor coupled to the axis of rotation in pitch.

Furthermore, all the sensors are duplicated and the microcontroller 52, 54 of the first path 42, 44 receives, via the formatting circuit 56, signals 66 coming, for each axis of rotation, from a first series of angular position, angular velocity and/or angular acceleration sensors, and from force sensors, and the microcontroller 53, 55 of the second path 43, 45 receives, via the formatting circuit 57, signals 67 coming, for each axis of rotation, from a second series of angular position, angular velocity and/or angular acceleration sensors, and from force sensors.

Each path 42, 43, 44, 45 is furthermore supplied with electrical energy 68, in particular DC voltage, via the external connectors 41. The supply voltage 68 is supplied to a voltage multiplier circuit 71 and 72, respectively, which supplies the supply circuits 58, 59 and 60, 61, respectively, of the motors. The supply voltage 68 is also supplied to a converter 73 and 74, respectively, of the voltage which supplies each microcontroller 52, 53, 54, 55 and also the various sensors of the electromechanical box 23, 24. Preferably, this supply voltage 68 is supplied by two different voltage sources, one supplying the microcontroller 52, 54 of the first path and one of the actuating motors 35, 36 of each axis of rotation, and the other supplying the microcontroller 53, 55 of the second path and the other actuating motor 35, 36 of each axis of rotation.

The external connectors 41 furthermore have serial ports 75 and 76, respectively, for example of the RS422 type, and also input ports 77 and 78, respectively, and output ports 79 and 80, respectively, these ports 75 to 80 communicating with the microcontroller 52, 53, 54, 55 via a filter circuit 69 and 70, respectively, and a signal shaping circuit 88 and 89, respectively.

The two paths 42, 44 and 43, 45, respectively, are also connected to one another by an internal serial bus 97 and 98, respectively.

FIG. 5 shows an example of the equipment and connection architecture of the sensors. Each piloting member 21, 22 is equipped, for each of the axes 25, 26, with six sets of angular position sensors 27, 28, angular velocity sensors 29, 30 and force sensors 31, 32, namely:
for the pitch axis 25:
a first set 81 comprising an angular position sensor, an angular velocity sensor and a force sensor, which are connected to the first path 42, 44 of the piloting member 21, 22 considered;
a second set 82 comprising an angular position sensor, an angular velocity sensor and a force sensor, which are connected to the second path 43, 45 of the piloting member 21, 22 considered;
a third set 83 comprising an angular position sensor, an angular velocity sensor and a force sensor, which are connected to the first path 44, 42 of the other piloting member 22, 21;
a fourth set 84, a fifth set 85, a sixth set 86 comprising an angular position sensor and a force sensor, which are connected to the automatic piloting computer system 87 of the aircraft (flight command computer);
   for the roll axis 26:
a first set 91 comprising an angular position sensor, an angular velocity sensor and a force sensor, which are connected to the first path 42, 44 of the piloting member 21, 22 considered;
a second set 92 comprising an angular position sensor, an angular velocity sensor and a force sensor, which are connected to the second path 43, 45 of the piloting member 21, 22 considered;
a third set 93 comprising an angular position sensor, an angular velocity sensor and a force sensor, which are connected to the second path 45, 43 of the other piloting member 22, 21;
a fourth set 94, a fifth set 95, a sixth set 96, each comprising an angular position sensor and a force sensor, which are connected to the automatic piloting computer system 87 of the aircraft (flight command computer).

The redundancy which makes it possible to guarantee that there is no single failure causing loss of detection of a parameter is thus ensured.

FIG. 6 shows the architecture of the data links of the electronic microcontrollers 52, 53, 54, 55 of the different paths of the electronic command/monitoring units 47, 48 of the different piloting members. The four microcontrollers 52, 53, 54, 55 are connected to one another in pairs by six serial buses—the two internal serial buses 97, 98 and four external serial buses 99, 100, 101, 102 connected to the serial ports 75, 76 of the connectors 41, one pair of such serial ports 75, 76 being provided for each microcontroller.

A first external serial bus 99 connects the microcontroller 52 of the first path 42 of the electronic command/monitoring unit 47 associated with the mini-stick 21 of the captain to the microcontroller 54 of the first path 44 of the electronic command/monitoring unit 48 associated with the mini-stick 22 of the copilot. A second external serial bus 100 connects the microcontroller 53 of the second path 43 of the electronic command/monitoring unit 47 associated with the mini-stick 21 of the captain to the microcontroller 55 of the second path 45 of the electronic command/monitoring unit 48 associated with the mini-stick 22 of the copilot. A third external serial bus 101 connects the microcontroller 52 of the first path 42 of the electronic command/monitoring unit 47 associated with the mini-stick 21 of the captain to the microcontroller 55 of the second path 45 of the electronic command/monitoring unit 48 associated with the mini-stick 22 of the copilot. A fourth external serial bus 102 connects the microcontroller 53 of the second path 43 of the electronic command/monitoring unit 47 associated with the mini-stick 21 of the captain to the microcontroller 54 of the first path 44 of the electronic command/monitoring unit 48 associated with the mini-stick 22 of the copilot.

Furthermore, each microcontroller 52, 53, 54, 55 is preferably connected to a central computer system 103 of the aircraft, so as to form a CAN type network therewith.

Tables 1 and 2 below show the main signals associated with each electronic microcontroller 52, 53, 54, 55, in particular those received at their receiving inputs concerning their functionalities with regard to the invention, i.e. the commanding and the electronic operational control of the piloting members (other signals not shown in the tables may be associated with these microcontrollers, in particular concerning certain safety functions or specific movement commands of the piloting members for generating particular force feedback sensations).

Each table shows for each axis (roll or pitch) the signals received at the receiving inputs of the microcontroller coming from the sensors associated with the mini-stick controlled by the electronic command/monitoring unit to which the microcontroller belongs or with the other mini-stick.

As can be seen, each microcontroller receives at the input signals coming from the various sensors, including for at least one axis of the other mini-stick than the mini-stick controlled by the electronic command/monitoring unit to which it belongs.

Each of the microcontrollers thus constitutes both a main monitoring circuit for digital processing of the signals received from the sensors associated with the controlled mini-stick, and a cross-monitoring circuit which makes it possible to carry out the operational control of the other mini-stick, at least for one axis thereof. In practice, in the example given, the first microcontroller 52, 54 carries out on the one hand the main monitoring of the roll and pitch axes of the controlled mini-stick, and also, for each axis, the commanding of a first motor associated with this axis, and on the other hand the cross-monitoring of the pitch axis of the other mini-stick; and the second microcontroller 53, 55 carries out on the one hand the main monitoring of the roll and pitch axes of the controlled mini-stick, and also, for each axis, the commanding of a second motor associated with this axis, and on the other hand the cross-monitoring of the roll axis of the other mini-stick. It goes without saying that this architecture is merely an example and in particular that each microcontroller may carry out the cross-monitoring of both the roll and pitch axes.

TABLE 1
FIRST MICROCONTROLLER 52, 54

| | | | property with regard to |
|---|---|---|---|
| axis | mini-stick concerned | signal | electronic control unit |
| pitch | controlled mini-stick | torque sensor of 81 | INPUT |
| pitch | controlled mini-stick | mini-stick position sensor of 81 | INPUT |
| pitch | controlled mini-stick | mini-stick velocity sensor of 81 | INPUT |
| roll | controlled mini-stick | torque sensor of 91 | INPUT |
| roll | controlled mini-stick | mini-stick position sensor of 91 | INPUT |
| roll | controlled mini-stick | mini-stick velocity sensor of 91 | INPUT |
| pitch | other mini-stick | torque sensor of 83 | INPUT |
| pitch | other mini-stick | mini-stick position sensor of 83 | INPUT |
| pitch | other mini-stick | mini-stick velocity sensor of 83 | INPUT |
| roll | controlled mini-stick | motor position sensor of 91 | INPUT |
| roll | controlled mini-stick | motor supply current | INPUT |
| roll | controlled mini-stick | motor supply voltage | INPUT |
| roll | controlled mini-stick | motor PWM command signals | OUTPUT |
| pitch | controlled mini-stick | motor position sensor of 81 | INPUT |
| pitch | controlled mini-stick | motor supply current | INPUT |
| pitch | controlled mini-stick | motor supply voltage | INPUT |
| pitch | controlled mini-stick | motor PWM command signals | OUTPUT |
| pitch and roll | controlled mini-stick | automatic pilot engagement command | INPUT |
| pitch | controlled mini-stick | automatic pilot position command | INPUT |
| roll | controlled mini-stick | automatic pilot position command | INPUT |
| pitch and roll | both mini-sticks | serial bus 99 | INPUT/OUTPUT |
| pitch and roll | both mini-sticks | serial bus 101 or 102 | INPUT/OUTPUT |
| pitch and roll | controlled mini-stick | internal serial bus 97 or 98 | INPUT/OUTPUT |
| pitch and roll | controlled mini-stick | CAN bus | INPUT/OUTPUT |

TABLE 2
SECOND MICROCONTROLLER 53, 55

| | | | property with regard to |
|---|---|---|---|
| axis | mini-stick concerned | signal | electronic control unit |
| pitch | controlled mini-stick | torque sensor of 82 | INPUT |
| pitch | controlled mini-stick | mini-stick position sensor of 82 | INPUT |
| pitch | controlled mini-stick | mini-stick velocity sensor of 82 | INPUT |
| roll | controlled mini-stick | torque sensor of 92 | INPUT |
| roll | controlled mini-stick | mini-stick position sensor of 92 | INPUT |
| roll | controlled mini-stick | mini-stick velocity sensor of 92 | INPUT |
| roll | other mini-stick | torque sensor of 93 | INPUT |
| roll | other mini-stick | mini-stick position sensor of 93 | INPUT |
| roll | other mini-stick | mini-stick velocity sensor of 93 | INPUT |
| roll | controlled mini-stick | motor position sensor of 92 | INPUT |
| roll | controlled mini-stick | motor supply current | INPUT |
| roll | controlled mini-stick | motor supply voltage | INPUT |
| roll | controlled mini-stick | motor PWM command signals | OUTPUT |
| pitch | controlled mini-stick | motor position sensor of 82 | INPUT |
| pitch | controlled mini-stick | motor supply current | INPUT |
| pitch | controlled mini-stick | motor supply voltage | INPUT |
| pitch | controlled mini-stick | motor PWM command signals | OUTPUT |
| pitch and roll | controlled mini-stick | automatic pilot engagement command | INPUT |
| pitch | controlled mini-stick | automatic pilot position command | INPUT |
| roll | controlled mini-stick | automatic pilot position command | INPUT |
| pitch and roll | both mini-sticks | serial bus 100 | INPUT/OUTPUT |
| pitch and roll | both mini-sticks | serial bus 102 or 101 | INPUT/OUTPUT |
| pitch and roll | controlled mini-stick | internal serial bus 97 or 98 | INPUT/OUTPUT |
| pitch and roll | controlled mini-stick | CAN bus | INPUT/OUTPUT |

FIG. 7 shows the logic employed by each electronic microcontroller 52 to 55 for the cross-monitoring on one of the two axes 25, 26. For this axis 25, 26, the electronic microcontroller receives the signals coming from the sensors 27 to 30, namely at least a position signal 110 (value of angle of rotation θ) of the controlled mini-stick 21, 22, and a position signal 111 of the other mini-stick 22, 21. It also preferably receives a velocity signal 112 of the controlled mini-stick and a velocity signal 113 of the other mini-stick 22, 21. These velocity signals 112, 113 may come from velocity sensors or be calculated by differentiation with respect to the time of the position signals θ(t) coming from the sensors measuring the angular position of each mini-stick over time. The electronic microcontroller also preferably receives a signal 152 representing the acceleration of the controlled mini-stick 21, 22 and a signal 153 representing the acceleration of the other mini-stick 22, 21. These acceleration signals 152, 153 may come from angular acceleration sensors or be calculated by double differentiation with respect to the time of the position signals θ(t) coming from the sensors measuring the angular position of each mini-stick over time.

Based on these signals, the electronic microcontroller 52 to 55 is adapted to execute a module 114 for calculating a value representing the theoretical forces. This calculating module 114 applies predetermined laws (represented by stored data, for example in the form of tables) which make it possible to calculate, for each axis of each mini-stick, the theoretical torque corresponding to the angular position, and, where appropriate, preferably also the theoretical torque corresponding to the angular velocity of this axis and/or the theoretical torque corresponding to the angular acceleration of this axis.

When the two mini-sticks 21, 22 are logically and electronically coupled to one another by the electronic command/monitoring units 47, 48, the calculating module 114 calculates, for each axis of each mini-stick, a theoretical value 115 of the torque which is to be imparted to one of the axes for each piloting member 21, 22. This theoretical value 115 is the algebraic sum (taking account of the signs, i.e. the directions of the torques) of the theoretical torques corresponding to the angular position, the angular velocity and the angular acceleration previously calculated. It should be noted that as soon as the two mini-sticks 21, 22 are coupled, the theoretical value 115 for one of the mini-sticks is the same as that obtained for the other mini-stick.

Furthermore, the electronic microcontroller 52 to 55 also receives, for the axis considered, the values coming from the force sensors 31, 32, i.e. a signal 116 of the torque measured on the axis for the controlled mini-stick 21, 22, and a signal 117 of the torque measured on the axis for the other mini-stick 22, 21. The electronic microcontroller 52 to 55 executes a module 118 producing the algebraic sum (taking account of the signs, i.e. the directions of the torques) of the measured torques, this module 118 supplying a value 119 representing this algebraic sum of the measured cumulated forces. The electronic microcontroller 52 to 55 executes a module 120 which calculates the difference 121 between the theoretical value 115 and the value 119 representing the algebraic sum of the measured torques, and a module 122 which 122 which compares this difference value 121 with a stored predetermined threshold value 123. When the value 121 is greater as an absolute value than the threshold value 123, the microcontroller 52 to 55 emits a signal 124 representing the existence of an operating fault. This cross-monitoring carried out via the algebraic sum of the signals of the measured torques of the two piloting members and detection of a deviation on this sum is particularly simple and amply sufficient. Nevertheless, in a variant, any other function for combining the signals of the two piloting members may be used, in particular in polynomial form or the like.

If the two mini-sticks 21, 22 are not coupled electronically, i.e. are independent of one another, the theoretical value 115 (which is still, for the mini-stick 21, 22 considered, the algebraic sum of the theoretical torques due to the angular position, the angular velocity and the angular acceleration, where appropriate), is compared with the value of the signal 116, or 117, of the torque measured on the axis of the mini-stick 21, 22 considered by the module 120 which calculates a difference between these values, this difference once again being compared as an absolute value with a threshold value, the electronic microcontroller emitting a signal representing the existence of a fault if this threshold value is exceeded.

FIG. 8 shows the state of one of the electronic command/monitoring units 47, 48 in normal operation. Each electronic command/monitoring unit 47, 48 supplies the command signals 62, 64; 63, 65 simultaneously for the two motors 35, 36 of each axis of the controlled mini-stick. For each axis, the first microcontroller 52, 54 supplies a signal for commanding a first motor at 50% of the torque which is to be imparted to this axis, and the second microcontroller 53, 55 supplies a signal for commanding a second motor at 50% of the torque which is to be imparted to this axis.

In addition, each microcontroller is multifunctional and performs on the one hand motor command functionalities for each degree of freedom according to position and velocity servo loops for the generation of force feedback sensations, and, on the other hand, command signal monitoring functionalities which make it possible to avoid the deviations and detect the faults.

In normal operation, when one of the electronic microcontrollers 52, 54, or 53, 55 of an electronic command/monitoring unit 47, 48 performs command functions on one of the axes of the controlled mini-stick, the other electronic microcontroller 53, 55, or 52, 54 of this same electronic command/monitoring unit 47, 48 performs monitoring functions on this axis.

Furthermore, the two electronic microcontrollers of a same electronic command/monitoring unit 47, 48 are associated with one another so as to function as master/slave. The master electronic microcontroller performs the functions of commanding and monitoring of the current of one of the motors on one of the axes, and the slave microcontroller performs functions of monitoring and controlling of the current of the other motor of the same axis. When one electronic microcontroller is the master on one axis, it is the slave for the other axis.

FIG. 9 illustrates an exemplary embodiment of such master/slave operating logic for the microcontrollers of one of the electronic command/monitoring units 47, 48 for one of the axes 21, 22.

The master operation is as follows:

The first microcontroller 52, 54 receives the signals 116, 117 of the forces measured on the axis, calculates the algebraic sum thereof and executes a module 125 which makes it possible to apply the above-mentioned predetermined law connecting the position and torque, in order to supply a value 126 representing a theoretical reference position of the axis of the controlled mini-stick. The module 127 calculates the difference 128 between this value 126 and the value of the signal 110 for measuring the position of the controlled mini-stick. This difference 128 is used by a module 129 for calculating a torque desired value 130. This module 129 executes a predetermined automatic control, for example of the PID (proportional-integral-derivative) type. The first microcontroller 52, 54 therefore in this way implements a position servo loop 132 based on the measured torque values 116, 117.

The torque desired value 130 is supplied to a fault detection module 131, then to the input of a current servo loop 133 of one 35a, 36a of the motors for actuating the axis. This loop 133 comprises a module 134 which compares the desired value 130 with a value 135 representing the measured torque actually supplied to the motor by the supply circuit 58, 60. This value 135 is for example a measured value of a current supplied by the supply circuit 58, 60. The difference 136 between the desired value 130 and the measured value 135 is supplied to a module 137 which executes an automatic control (for example of the PID type) for controlling the current which delivers a command signal 138 for the supply circuit 58, 60 which supplies the motor 35a, 36a as a function of this signal 138.

The slave operation is as follows:

The second microcontroller 53, 55 comprises a position servo loop 139 based on the measured forces 116, 117, this loop 139 being identical to the position servo loop 132 employed by the first microcontroller 52, 54. This loop 139 therefore also supplies a torque desired value 140 which is supplied to a fault detection module 141, then to the input of a current servo loop 143 of the other 35b, 36b of the motors for actuating the axis. This current servo loop 143 is identical to the current servo loop 133 employed by the first electronic microcontroller 52, 54.

Furthermore, the torque desired value 130 produced by the first electronic microcontroller 52, 54 is supplied to the second electronic microcontroller 53, 55 and used by an operational control module 145 executed by this second electronic microcontroller 53, 55 to compare it with the torque desired value 140 produced by the latter. This module 145 detects a difference between these two values 130, 140, and compares this difference, as an absolute value, with a predetermined threshold value. If this threshold value is exceeded, the module 145 generates an operating fault signal used for example by the module 141. Thus, the second electronic microcontroller 53, 55 carries out a slave operational control of the first electronic microcontroller 52, 54.

As can be seen from FIG. 8, the two microcontrollers exchange the torque desired value signals 130, 140 on the internal serial bus 97, 98 in full duplex, each signal having a master or slave status, as the case may be. In FIG. 8, the blocks 155 and 156, respectively, representing the microcontrollers represent the status of the microcontroller with regard to each axis 25 and 26, respectively. A master command status is represented by hatching, and a slave command status is represented by an absence of hatching in the corresponding part of the block 155, 156. A function for operational control of the axis 25, 26 is represented by insertion of the letter “M” in the block 155, 156.

FIG. 10 is similar to FIG. 8 but shows the state of the electronic command/monitoring unit 47, 48 in the event of a fault on at least one electrical supply circuit 58 to 61 of a motor or on at least one motor 35, 36. In the example shown, the existence of such a fault on the operation of the second motor 35b for actuating the pitch axis 25 normally master-commanded via the second path 43, 45 is assumed. As can be seen, the electronic command/monitoring unit is itself reconfigured such that the first microcontroller 52, 54 which is normally the slave becomes the master and that the command signal 62 for the first motor 35a controls 100% of the torque to be delivered on this axis 25. In addition, the second microcontroller 53, 55 is also reconfigured to provide slave operational control on the pitch axis 25.

FIG. 11 shows the state of the electronic command/monitoring unit 47, 48 in the event of a fault on one of the microcontrollers, namely the second microcontroller 53, 55 in the example shown. The electronic command/monitoring unit 47, 48 is itself reconfigured so that the other electronic microcontroller 52, 54 becomes the master in the commands on the two axes and supplies 100% of the torque by the command signals 62 and 65, respectively.

The invention makes it possible to ensure total resistance of the device to a single failure and to do so in an extremely simple, efficient and economical manner. It may have numerous variant embodiments and applications.

1. Electronic control device for an aircraft piloting member, called the controlled piloting member, connected to at least one flying member of the aircraft, said controlled piloting member being mounted and guided on an electromechanical supporting box on at least one degree of freedom, said electro-mechanical supporting box comprising:
for each degree of freedom of the controlled piloting member with respect to said electromechanical supporting box, at least one motor for actuating the controlled piloting member on said degree of freedom,
sensors associated with the controlled piloting member to detect at least the position thereof on said at least one degree of freedom,
characterised in that it comprises a command/monitoring unit of the controlled piloting member, in that said command/monitoring unit comprises at least one electronic microcontroller, and in that each of said at least one electronic microcontroller is adapted to:
deliver command signals for at least one actuating motor on one degree of freedom, called commanded degree of freedom of the controlled piloting member,
receive signals, called monitored signals, delivered by sensors chosen from
sensors associated with at least a second degree of freedom, called the monitored degree of freedom, of the controlled piloting member, said monitored degree of freedom of the controlled piloting member being distinct from said commanded degree of freedom,
and sensors associated with at least one monitored degree of freedom of another piloting member distinct from said controlled piloting member, said monitored degree of freedom of said another piloting member being distinct from said commanded degree of freedom of the controlled piloting member,
carry out a monitoring digital processing of said monitored signals, said monitoring digital processing being adapted to detect any deviation of said monitored signals corresponding to an operating fault and to generate a signal representing such an operating fault.

2. Device according to claim 1, characterised in that said electromechanical supporting box comprises force sensors associated with the controlled piloting member to detect the forces imparted thereto on each commanded degree of freedom, and in that said command/monitoring unit comprises inputs for receiving the signals delivered by said force sensors, and each of said at least one electronic microcontroller is adapted to receive said signals, and to deliver command signals for at least one actuating motor so as to create an electrically simulated variable force feedback sensation in the piloting member.

3. Device according to claim 1, characterised in that the controlled piloting member belongs to a piloting device comprising said controlled piloting member and another piloting member, called the other piloting member, both piloting members being connected to at least one same flying member of the aircraft, and in that said command/monitoring unit of the controlled piloting member comprises:
inputs, called cross-monitoring inputs, for receiving monitored signals, said cross-monitored signals, delivered by sensors associated with said other piloting member,
for each degree of freedom, at least one electronic microcontroller receiving said cross-monitored signals received at the cross-monitoring inputs, and said microcontroller being adapted to deliver command signals for at least one actuating motor on said commanded degree of freedom of the controlled piloting member so as to carry out electronic servo coupling of the two piloting members.

4. Device according to claim 1, characterised in that the controlled piloting member belongs to a piloting device comprising said piloting members being mounted on two respective electromechanical boxes with the same degrees of freedom and both connected to at least one same flying member of the aircraft, and in that said command/monitoring unit comprises:
for each of said monitored degree of freedom of the controlled piloting member, an electronic microcontroller, called main monitoring microcontroller, for digital processing of said monitored signals delivered by sensors associated with the controlled piloting member, and adapted to detect any deviation of these signals corresponding to an operating fault and to generate a signal representing such an operating fault,
inputs, called cross-monitoring inputs, for receiving monitored signals, said cross-monitored signals, delivered by sensors associated with said other piloting member,
for each monitored degree of freedom of said other piloting member, one and only one electronic microcontroller, called the cross-monitoring microcontroller, specific to this degree of freedom, said cross-monitoring microcontroller being adapted to carry out digital processing of said cross-monitored signals received at said cross-monitoring inputs, and to detect any deviation of these signals corresponding to a fault and to generate a signal representing such an operating fault.

5. Device according to claim 3, characterised in that said cross-monitoring inputs comprise at least one input for receiving at least one cross-monitored position signal of said other piloting member, delivered by a position sensor associated with said other piloting member.

6. Device according to claim 5, characterised in that said cross-monitoring inputs comprise at least one input for receiving at least one cross-monitored force signal representing forces actually exerted on the other piloting member, delivered by at least one force sensor associated with said other piloting member, and in that, for each degree of freedom, said cross-monitoring electronic microcontroller is adapted to compare a value, called the force measured value, determined at least from said cross-monitored force signal, with a reference value calculated according to a predetermined law from at least one position signal of said other piloting member.

7. Device according to claim 6, characterised in that said cross-monitoring electronic microcontroller is adapted to compare the difference between said force measured value and said reference value with a predetermined threshold value, and to generate a signal representing a fault when this difference exceeds said predetermined threshold value.

8. Device according to claim 1, characterised in that the controlled piloting member belongs to a piloting device comprising, said piloting member being mounted on two respective electromechanical boxes with the two same degrees of freedom and both connected to at least one same flying member of the aircraft, said command/monitoring unit comprises:
a first electronic microcontroller having the functions:
of delivering master command signals for a first actuating motor on a first degree of freedom of the controlled piloting member,
of delivering slave command signals for a first actuating motor on a second degree of freedom of the controlled piloting member,
of carrying out main monitoring of the controlled piloting member on the second degree of freedom,
of carrying out cross-monitoring of the other piloting member on one of the two degrees of freedom, in particular the second degree of freedom,
a second electronic microcontroller having the functions:
of delivering master command signals for a second actuating motor on a second degree of freedom of the controlled piloting member,
of delivering slave command signals for a second actuating motor on the first degree of freedom of the controlled piloting member,
of carrying out main monitoring of the controlled piloting member on the first degree of freedom,
of carrying out cross-monitoring of the other piloting member on the other of the two degrees of freedom, in particular the first degree of freedom.

9. Device according to claim 1, characterised in that said command/monitoring unit is encapsulated in a box which can be mounted on the electromechanical supporting box of the controlled piloting member.

10. Piloting device of an aircraft comprising at least one piloting member connected to at least one flying member of the aircraft, characterised in that it comprises an electronic control device according to claim 1 for a piloting member.

11. Piloting device according to claim 10 comprising two piloting members both connected to at least one same flying member of the aircraft, characterised in that it comprises, for each piloting member, an electronic control device specific to each piloting member.

12. Piloting device according to claim 11, characterised in that the two electronic control devices are identical.

13. Aircraft characterised in that it comprises at least one piloting device according to claim 10.
